(19) United States
(12) Patent Application Publication
(10) Pub. No.: US 2015/0299947 A1
(43) Pub. Date: Oct. 22, 2015

(54) CARPET, CARPET BACKINGS AND METHODS

(71) Applicant: Shaw Industries Group, Inc., Dalton, GA (US)

(72) Inventors: Julie Brumbelow, Dalton, GA (US); Jill Suhm, Marietta, GA (US); Jeff Wright, Cartersville, GA (US); George Cavanaugh, Dalton, GA (US)

(21) Appl. No.: 14/254,645

(22) Filed: Apr. 16, 2014

(51) Int. Cl. D06N 7/00; B32B 38/00; B32B 37/15; B32B 37/12

(52) U.S. Cl. CPC D06N 7/0076; D06N 7/0068; B32B 37/1284; B32B 38/0004; B32B 37/153; B32B 2471/02

(57) ABSTRACT

The present invention pertains to carpet and method of making it. In one aspect, the carpet includes (a) a primary backing which has a face and a back surface, (b) a plurality of fibers attached to the primary backing and extending from the face of the primary backing and exposed at the back surface of the primary backing, and (c) an adhesive backing adjacent to the back surface of the primary backing. The method includes extrusion coating adhesive backing onto the back surface of a primary backing. The constructions and methods described herein are particularly suited for making carpet pieces with enhanced durability and washability.

### FIELD OF THE INVENTION

This invention relates to carpets and methods of making carpets, wherein, for each, the carpets comprise at least one elastomeric polypropylene backing material. In a particular instance, the invention relates to a carpet and a method of making a carpet by an extrusion coating technique, wherein for each the carpet comprises a backing material comprised of at least one flexible polypropylene backing material.

### BACKGROUND

The present invention pertains to any carpet constructed with a primary backing material and includes tufted carpet and non-tufted carpet such as needle punched carpet. Although specific embodiments are amenable to tufted and non-tufted carpet, tufted carpet is preferred.

As illustrated in FIG. 1, tufted carpets are composite structures, which include yarn (which is also known as a fiber bundle), a primary backing material having a face surface and a back surface, an adhesive backing material and, optionally, a secondary backing material. To form the face surface of tufted carpet, yarn is tufted through the primary backing material such that the longer length of each stitch extends through the face surface of the primary backing material. Typically, the primary backing material is made of a woven or non-woven material such as a thermoplastic polymer, most commonly polypropylene.

The face of a tufted carpet can generally be made in three ways. First, for loop pile carpet, the yarn loops formed in the tufting process are left intact. Second, for cut pile carpet, the yarn loops are cut, either during tufting or after, to produce a pile of single yarn ends instead of loops. Third, some carpet styles include both loop and cut pile. One variety of this hybrid is referred to as tip-sheared carpet where loops of differing lengths are tufted followed by shearing the carpet at a height so as to produce a mix of uncut, partially cut, and completely cut loops. Alternatively, the tufting machine can be configured so as to cut only some of the loops, thereby leaving a pattern of cut and uncut loops. Whether loop, cut, or a hybrid, the yarn on the back side of the primary backing material comprises tight, unextended loops.

The combination of tufted yarn and a primary backing material without the application of an adhesive backing material or secondary backing material is referred to in the carpet industry as raw tufted carpet or greige goods. Greige goods become finished tufted carpet with the application of an adhesive backing material and an optional secondary backing material to the back side of the primary backing material. Finished tufted carpet can be prepared as broad-loomed carpet in rolls typically 6 or 12 feet wide. Alternatively, carpet can be prepared as carpet tiles, typically 18 inches square in the United States and 50 cm. square elsewhere.

The adhesive backing material is applied to the back face of the primary backing material to affix the yarn to the primary backing material. Typically, the adhesive backing material is applied by a pan applicator using a roller, a roll over a roller or a bed, or a knife (also called a doctor blade) over a roller or a bed. Properly applied adhesive backing materials do not substantially pass through the primary backing material.

Most frequently, the adhesive backing material is applied as a single coating or layer. The extent or tenacity to which the yarn is affixed is referred to as tuft lock or tuft bind strength. Carpets with sufficient tuft bind strength exhibit good wear resistance and, as such, have long service lives. Also, the adhesive backing material should substantially penetrate the yarn (fiber bundle) exposed on the backside of the primary backing material and should substantially consolidate individual fibers within the yarn. Good penetration of the yarn and consolidation of fibers yields good abrasion resistance. Moreover, in addition to good tuft bind strength and abrasion resistance, the adhesive material should also impart or allow good flexibility to the carpet in order to facilitate easy installation of the carpet.

The secondary backing material is typically a lightweight scrim made of woven or non-woven material such as a thermoplastic polymer, most commonly polypropylene. The secondary backing material is optionally applied to the backside of the carpet onto the adhesive backing material, primarily to provide enhanced dimensional stability to the carpet structure as well as to provide more surface area for the application of direct glue-down adhesives.

Alternative backing materials may also be applied to the backside of the adhesive backing material and/or to the backside of the secondary backing material, if present. Alternative backing materials may include foam cushioning (e.g. foamed polyurethane) and pressure sensitive floor adhesives. Alternative backing materials may also be applied, for example, as webbing with enhanced surface area, to facilitate direct glue-down adhesive installations (e.g., in contract commercial carpeting, automobile carpet and airplane carpet where the need for cushioning is oft times minimal). Alternative backing materials can also be optionally applied to enhance barrier protection respecting moisture, insects, and foodstuffs as well as to provide or enhance fire suppression, thermal insulation, and sound dampening properties of the carpet.

Known adhesive backing materials include curable latex, urethane or vinyl systems, with latex systems being most common. Conventional latex systems are low viscosity, aqueous compositions that are applied at high carpet production rates and offer good fiber-to-backing adhesion, tuft bind strength and adequate flexibility. Generally, excess water is driven off and the latex is cured by passing through a drying oven. Styrene butadiene rubbers (SBR) and natural latex are the most common polymers used for latex adhesive backing materials. Typically, the latex backing system is heavily filled with an inorganic filler such as calcium carbonate or Aluminum Trihydrate and includes other ingredients such as antioxidants, antimicrobials, flame retardants, smoke suppressants, wetting agents, and froth aids.

Conventional latex adhesive backing systems can have certain drawbacks. As one important drawback, typical latex adhesive backing systems do not provide a moisture barrier. Another possible drawback, particularly with a carpet having polypropylene yarn and polypropylene primary and secondary backing materials, is the dissimilar polymer of latex systems along with the inorganic filler can reduce the recyclability of the carpet.

In view of these drawbacks, some in the carpet industry have begun seeking suitable replacements for conventional latex adhesive backing systems. Unfortunately, hot melt adhesive systems are generally considered not completely suitable replacements for conventional latex adhesive backings. Typical hot melt systems based on EVA and other copolymers of ethylene and unsaturated comonomers can require considerable formulating and yet often yield inadequate tuft bind strengths. However, the most significant deficiency of typical hot melt system is their melt strengths which are generally too low to permit application by a direct extrusion coating technique. As such, polyolefin hot melt systems are typically applied to primary backings by relatively slow, less efficient techniques such as by the use of heated doctor blades or rotating melt transfer rollers.

While unformulated high pressure low density polyethylene (LDPE) can be applied by a conventional extrusion coating technique, LDPE resins typically have poor flexibility which can result in excessive carpet stiffness. Conversely, those ordinary polyolefins that have improved flexibility, such as ultra low density polyethylene (ULDPE) and ethylene/propylene interpolymers, still do not possess sufficient flexibility, have excessively low melt strengths and/or tend to draw resonate during extrusion coating. To overcome extrusion coating difficulties, ordinary polyolefins with sufficient flexibility can be applied by lamination techniques to insure adequate yarn-to-backing adhesion; however, lamination techniques are typically expensive and can result in extended production rates relative to direct extrusion coating techniques.

Although there are various systems known in the art of carpet backings, there remains a need for a carpet backing system which provides high tuft bind strength, good abrasion resistance, good flexibility, good anti-skid properties, and good washability to replace cured latex backing systems. Finally, a need also remains for an application method which permits high carpet production rates while achieving the desired characteristics of high tuft bind strength, abrasion resistance, barrier properties, flexibility, and washability.

### SUMMARY

In accordance with one aspect of the present invention, a carpet comprises a plurality of fibers, a primary backing material having a face and a back side, and an adhesive backing material. In one aspect, the plurality of fibers are attached to the primary backing material and protrude from the face of the primary backing material and are exposed on the back side of the primary backing material. In a further aspect, the adhesive backing material is disposed on the back side of the primary backing material, wherein the adhesive backing material is fused with or otherwise bonded to at least a portion of the plurality of fibers and at least a portion of the primary backing material to form a monolithic structure in which the consolidated fibers have high tuft bind strength.

Another aspect of the present invention is a method of making a carpet, the carpet including a plurality of fibers, a primary backing material having a face and a back side, and an adhesive backing material. The plurality of fibers being attached to the primary backing material and protruding from the face of the primary backing material and at least partially exposed on the back side of the primary backing material. In this aspect, the method comprises the step of extrusion coating the adhesive backing material onto the back side of the primary backing material, wherein the extrusion coated adhesive backing material is fused with or otherwise bonded to at least a portion of the plurality of fibers and at least a portion of the primary backing material to form a monolithic structure in which the consolidated fibers have high tuft bind strength.

A third aspect of the present invention is a method of making a carpet, the carpet comprising: providing a greige good having a face surface comprised of a plurality of fibers attached to a primary backing material having a face and a back side, and extruding an adhesive backing material that comprises a polypropylene elastomer that is in intimate contact with the back side of the primary backing material and can substantially penetrated and substantially consolidated at least a portion of the fibers with a binding strength achieved of between about 0.5 to about 25 pounds, preferably between 0.75 to about 17.5 pounds and more preferred between 1.0 to 10 pounds. The method can further comprise at least one additional step selected from the group consisting of: (a) preheating the greige good prior to the application of the adhesive backing material, (b) during the extrusion coating of the adhesive backing material, while at a temperature greater than or equal to the softening point of the adhesive backing material, subjecting the greige good and the adhesive backing material to nip roll pressure applied by nip rollers to force the adhesive backing material onto the back side of the primary backing material and into at least a portion of the plurality of fibers, and (c) chilling the extrudate as it passes through the nip rollers during the application of the adhesive backing material onto the back side of the primary backing material.

A fourth aspect of the present invention is a method of dyeing carpet pieces comprising providing carpet having a primary backing material having a face and a back side, yarn attached to the primary backing material, and an adhesive backing material bonded thereto by a step of extrusion coating, wherein the extrusion coated adhesive backing material is fused with or otherwise bonded to at least a portion of the plurality of fibers and at least a portion of the primary backing material; cutting and optionally binding the carpet into desired sizes to form carpet pieces; and dyeing the formed carpet pieces.

### BRIEF DESCRIPTION OF THE DRAWINGS

FIG. 1 is an illustration of a conventional, tufted carpet 10.

FIG. 2 is a schematic representation of an extrusion coating line for making a carpet rug.

FIG. 3 is a schematic representation of an extrusion coating line 20 for making a carpet rug.

FIG. 4 is a schematic illustration of a tufted carpet rug of the present invention.

FIG. 5 is a schematic representation of an dyeing line for dyeing carpet pieces according to the present invention.

### DETAILED DESCRIPTION OF THE INVENTION

The terms “intimate contact,” “substantial encapsulation,” and/or “substantial consolidation” are used herein to refer to mechanical adhesion or mechanical interactions (as opposed to chemical bonding) between dissimilar carpet components, irrespective of whether or not one or more carpet component is capable of chemically interacting with another carpet component. With respect to the mechanical adhesion or interactions of the present invention, there may be some effective amount of intermixing or inter-melting of polymeric materials. In some aspects, there is no continuous or integral fusing of various components as determined from visual inspection of photomicrographs (at 20× magnification) of the various carpet interfaces. Within this meaning, fusion of yarn or fiber bundles or of individual fibers to one another within a fiber bundle is not considered integral fusion in itself since fibers are referred to herein as one carpet component. However, in alternative aspects, for like polymers being used in the methodologies described herein, it is contemplated that there will be at least partial continuous or integral fusing of various components can occur such that fusion of yarn or fiber bundles or of individual fibers to one another within a fiber bundle is considered integral fusion in itself.

The term “intimate contact” refers to the mechanical interaction between the back surface of the primary backing material and the adhesive backing material. The term “substantial encapsulation” refers to the adhesive backing material significantly surrounding the yarn or fiber bundles at or in immediate proximity to the interface between the back surface of the primary backing material and the adhesive backing material. The term “substantial consolidation” refers to the overall integrity and dimensional stability of the carpet that is achieved by substantially encapsulating the yarn or fiber bundles and intimately contacting the back surface of the primary backing material with the adhesive backing material. A substantially consolidated carpet possesses high tuft bind strength, good component cohesiveness and good delamination resistance with respect to the various carpet or rug components.

The term “integral fusing” is used herein in the same sense as known in the art and refers to heat bonding of carpet components using a temperature above the melting point of the adhesive backing material. Integral fusing occurs when the adhesive backing material comprises the same polymer as either the fibers or primary backing material or both. However, integral fusing does not occur when the adhesive backing material comprises a different polymer than the fibers and primary backing material. By the term “same polymer,” it is meant that the monomer units of the polymers are of the same chemistry, although their molecular or morphological attributes may differ. Conversely, by the term “different polymer,” it is meant that, irrespective of any molecular or morphological differences, the monomer units of the polymers are of different chemistries. Thus, in accordance with the various definitions of the present invention, a polypropylene fiber material and a polyethylene adhesive backing material would not integrally fuse because these carpet/rug components are of different chemistries, whereas a polypropylene fiber material and a polypropylene adhesive backing material would integrally fuse because these carpet/rug components are of similar chemistries . . . .

The terms “carpet component” or “rug component” are used interchangeably herein to refer separately to carpet or rug fiber bundles, the primary backing material, and the adhesive backing material.

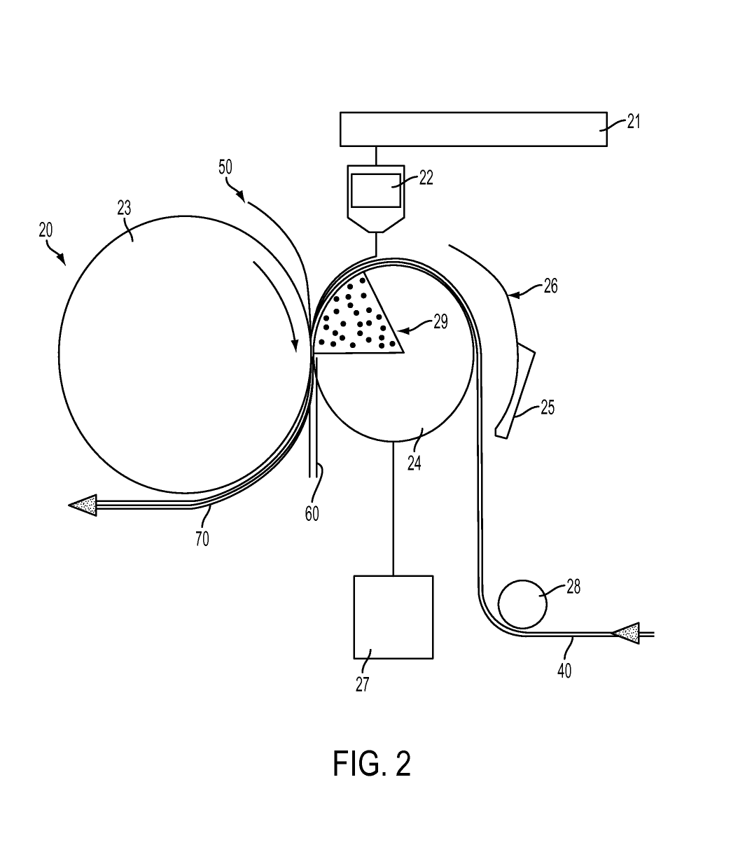

The term “extrusion coating” is used herein in its conventional sense to refer to an extrusion technique wherein a polymer composition usually in pellet-form is heated in an extruder to a temperature elevated above its melt temperature and then forced through a slot die to form a semi-molten or molten polymer web. The semi-molten or molten polymer web is continuously drawn down onto a continuously fed greige good to coat the backside of the greige good with the polymer composition. FIG. 2 illustrates an extrusion process of the present invention wherein, at the nip, the back surface of the greige good is oriented towards the chill roll and the face surface of the adhesive backing material oriented is towards the nip pressure roll. Extrusion coating is distinct from a lamination technique.

The term “lamination technique” is used herein in its conventional sense to refer to applying adhesive backing materials to greige goods by first forming the adhesive backing material as a solidified or substantially solidified film or sheet and thereafter, in a separate processing step, reheating or elevating the temperature of the film or sheet before applying it to the back surface of the primary backing material.

The term “implosion agent” is used herein to refer to the use of conventional blowing agents or other compounds which out-gas or cause out-gassing when activated by heat, usually at some particular activation temperature. In the present invention, implosion agents are used to implode or force adhesive backing material into the free space of yarn or fiber bundles.

The term “processing material” is used herein to refer to substances such as spin finishing waxes, equipment oils, sizing agents and the like, which can interfere with the adhesive or physical interfacial interactions of adhesive backing materials. Processing materials can be removed or displaced by a scouring or washing technique of the present invention whereby improved mechanical bonding is accomplished.

The terms “polypropylene carpet” and “polypropylene greige goods” are used herein to mean a carpet or greige goods substantially comprised of polypropylene fibers, irrespective of whether the primary backing material for the carpet or greige good is comprised of polypropylene or some other material.

The terms “nylon carpet” and “nylon greige goods” are used herein to mean a carpet or greige goods substantially comprised of nylon fibers, irrespective of whether the primary backing material for the carpet or greige good is comprised of nylon or some other material.

The term “VISTAMAXX™ 6202” means that polypropylene-based elastomer manufactured by ExxonMobil Chemical Company having a density of 0.863 g/cm3 and a Melt Mass-Flow Rate (MFR) of 20 g/10 min.

The term “EXXONMOBIL™ PP3155” means that polypropylene homopolymer resin manufactured by ExxonMobil Chemical Company having with a density of 0.9 g/cm3 and an MFR of 36 g/10 min.

The term “PICCOTAC™ 1115” means that hydrocarbon resin manufactured by Eastman Chemical, which is a relatively high molecular weight, aliphatic C5 resin derived from dienes and other reactive olefin.

In the present invention, during extrusion coating of the backside of carpet to apply an adhesive backing material, properly selected compositions comprising polypropylene-based elastomers show good penetration of carpet yarns (fiber bundles) and also allow good consolidation of the fibers within the yarn. When used for tufted carpets, the tuft bind strength and abrasion resistance of the carpet is increased by the penetration of the polypropylene-based elastomer composition into the yarn. Preferably, a tuft bind (or tuft lock) strength of 1 pounds (0.45 kg) or more is achieved, more preferably 2.5 pounds (1.13 kg) or more and most preferably 5 pounds (2.26 kg) or more. In addition to improved penetration of the yarn, polymer properties must be chosen such that a balance is maintained between extrusion coatability and abrasion resistance as well as between chemical resistance, desired carpet flexibility, and desired carpet washabilty.

When carpet greige goods are backed with an adhesive backing formed from properly selected compositions comprising polypropylene-based elastomers, the low flexural modulus of these polymers offers advantages in ease of carpet installation and general carpet handling. The properly selected compositions forming the adhesive backing can comprise polypropylene-based elastomers and, when employed as an adhesive backing material, can show enhanced mechanical adhesion to polypropylene, which improves the consolidation and delamination resistance of the various carpet layers and components, i.e., polypropylene fibers, fiber bundles, the primary backing material, and the adhesive backing material. Consequently, exceptionally good abrasion resistance and tuft bind strength can be obtained. Good abrasion resistance is especially important in commercial carpet cleaning operations as good abrasion resistance generally improves carpet durability. Exceptional tuft bind strength is desired when the formed carpet is cut into smaller carpet pieces for suitable use as floor mats, which are often required to be washed as a result of their use. Hence, exceptional tuft bind strength is needed to avoid delamination or separation when the carpet piece is washed multiple times.

In addition, carpets backed with an adhesive backing formed from properly selected compositions comprising polypropylene-based elastomers can provide a substantial fluid and particle barrier which enhances the hygienic properties of the formed carpet and carpet pieces. Further, it is contemplated that carpets formed by the compositions and methodology described herein can allow totally recyclable carpet products particularly where the carpet comprises polypropylene fibers.

In one aspect, the composition of the adhesive backing can comprise a polypropylene-based elastomer, a polypropylene homopolymer, and optionally a hydrocarbon resin. In one preferred aspect, the polypropylene-based elastomer can be VISTAMAXX™ 6202, which is manufactured by ExxonMobil Chemical Company, the polypropylene homopolymer can be EXXONMOBIL™ PP3155, which is manufactured by ExxonMobil Chemical Company, and the optional hydrocarbon resin can be PICCOTAC™ 1115, which can be manufactured by Eastman Chemical.

In a further aspect, the composition of the adhesive backing can optionally comprise a colorizing agent, such as, for example and without limitation, polyethylene-based resin containing titanium dioxide, carbon black, and/or any combination of pigments. It is also contemplated that composition of the adhesive backing can optionally comprise a blowing agent, such as, for example and without limitation, ECOCELL® Chemical Foam Concentrate, manufactured by Polyfil Corporation, that is suitable for use in extrusion with polyethylene, polypropylene, and other polomeric resins, and/or a filer, such as, for example and without limitation, CC-103, manufactured by Imerys, which is a calcium carbonate filler that is suitable for use in extrusion.

In another aspect, it is contemplated that the polypropylene-based elastomer can be used alone or can be blended or mixed with one or more synthetic or natural polymeric material. Suitable polymers for blending or mixing with polypropylene-based elastomers used in the present invention include, but are not limited to, homogeneously branched ethylene polymer, low density polyethylene, heterogeneously branched LLDPE, heterogeneously branched ULDPE, medium density polyethylene, high density polyethylene, grafted polyethylene (e.g. a maleic anhydride extrusion grafted heterogeneously branched linear low polyethylene or a maleic anhydride extrusion grafted homogeneously branched ultra low density polyethylene), ethylene acrylic acid copolymer, ethylene vinyl acetate copolymer, ethylene ethyl acrylate copolymer, polystyrene, polypropylene, polyester, polyurethane, polybutylene, polyamide, polycarbonate, rubbers, ethylene propylene polymers, ethylene styrene polymers, styrene block copolymers, and vulcanates.

The actual blending or mixing of various polymers and materials used in the adhesive backing may be conveniently accomplished by any technique known in the art including, but not limited to, melt extrusion compounding, dry blending, roll milling, melt mixing such as in a Banbury mixer and multiple reactor polymerization.

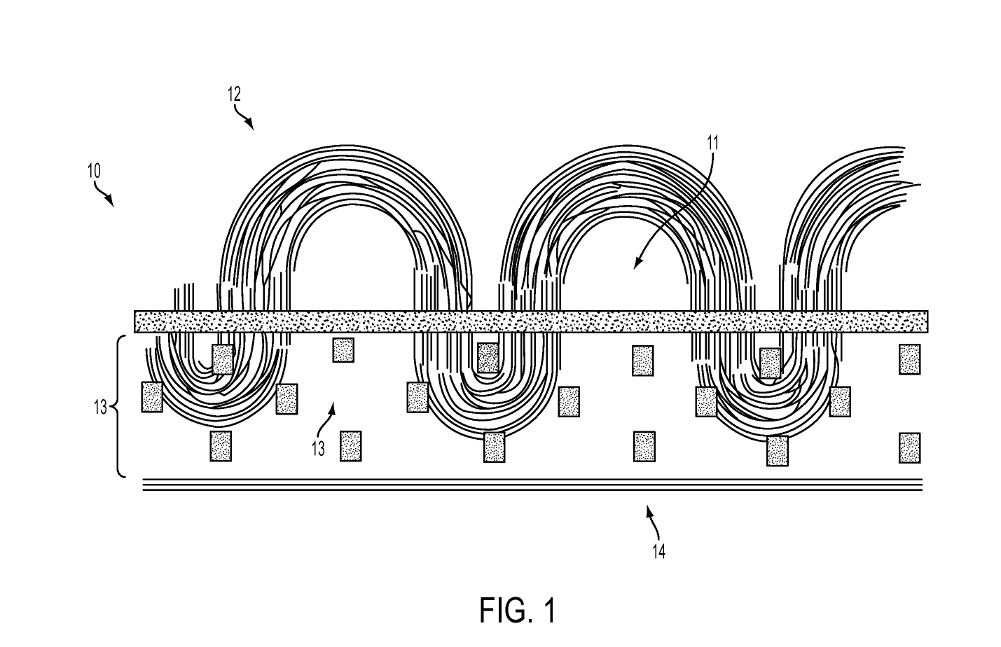

FIG. 1 is an illustration of a tufted carpet 10. The tufted carpet 10 is made of a primary backing material 11 with yarn 12 tufted therethrough; an adhesive backing material 13 which is in intimate contact with the back surface of the primary backing material 11, substantially encapsulates the yarn 12 and penetrates the yarn 12 and binds individual carpet fibers; and an optional secondary backing material 14 applied to the back surface of the adhesive backing material 13.

FIG. 2 is an illustration of an extrusion coating line 20 for making a carpet 70. The line 20 includes an extruder 21 equipped with a slot die 22, a nip roll 24, a chill roll 23, an exhaust hood 26, a greige good feeder roll 28 and a pre-heater 25. As illustrated, the nip roll can be equipped with a vacuum slot 29 to draw a vacuum across about 60 degrees or about 17 percent of its circumference and can be equipped with a vacuum pump 27. In one aspect, the slot die 22 dispenses the adhesive backing material in the form of a semi-molten or molten polymer web 30 onto the greige good 40 with the polymer web 30 towards the chill roll 23 and the greige good 40 towards the optional vacuum nip roll 24. The point where the nip roll 24 and the chill roll 23 are closest to one another is referred to as the nip 60.

The present invention is useful in producing carpets with face yarn made from various materials including, but not limited to, polypropylene, nylon, wool, cotton, acrylic, polyethylene, Polylactic acid, polyester and polytrimethylenetheraphthalate (PTT). However, again because one of the objects of the present invention is to provide a recyclable carpet such as, for example, a 100% polypropylene carpet, the most preferred yarn comprises a polypropylene. Most preferably, the yarn used in the present invention is an air entangled 2750 denier polypropylene yarn such as that produced by Shaw Industries, Inc. and sold under the designation “Permacolor 2750 Type 015.”

The preferred primary backing material comprises a polyolefin, more preferably polypropylene. Most preferably, the primary backing material is a slit film polypropylene sheet such as that sold by Propex or Synthetic Industries. Alternatively, other types of primary backing materials, such as non-woven webs, can also be used. Although other materials, such as polyesters or polyamides can be used for the primary backing material, it is preferred to use a polypropylene so that the objective of producing a carpet made entirely from polypropylene is achieved. In addition, polypropylene primary backing materials are typically lower in cost.

The method of tufting or needle-punching the yarn is not deemed critical to the present invention. Thus, any conventional tufting or needle-punching apparatus and stitch patterns can be used. Likewise, it does not matter whether tufted yarn loops are left uncut to produce a loop pile; cut to make cut pile; or cut, partially cut and uncut to make a face texture known as tip sheared.

After the yarn is tufted or needle-punched into the primary backing material, the greige good is typically rolled up with the back side of the primary backing material facing outward and held until it is transferred to the backing line.

Extrusion coating configurations include a monolayer T-type die, single-lip die coextrusion coating, dual-lip die coextrusion coating, and multiple stage extrusion coating. Preferably, the extrusion coating equipment is configured to apply a total coating weight of between about 1 and about 30 ounces/yd² (OSY) (about 0.03 and about 1.02 kg/m²), with between about 4 OSY (about 0.14 kg/m² and about 15 OSY (about 0.51 kg/m²) being most preferred.

Measured another way, the thickness of an unexpanded, collapsed extrusion coated adhesive backing material is in the range from about 1 to about 40 mils (about 0.03 to 1.02 mm), preferably from about 3 to about 30 mils (about 0.08 to about 0.76 mm), more preferably from about 4 to about 25 mils (about 0.10 to about 0.64 mm), and most preferably from about 5 to about 20 mils (about 0.13 to about 0.51 mm).

The line speed of the extrusion process will depend on factors such as the particular composition of the adhesive backing comprising the polypropylene elastomer being extruded, the exact equipment being used, and the weight of polymer being applied. Preferably, the line speed is between about 18 and about 250 ft./min. (about 5.5 and about 76.2 m/min.), more preferably between about 30 and about 130 ft./min. (about 9.1 and about 39.6 m/min.), most preferably between about 50 and about 100 ft./min. (about 15.2 and about 30.5 m/min.).

The extrusion coating melt temperature principally depends on the particular composition of the adhesive backing comprising the polypropylene elastomer being extruded. When using the most preferred polypropylene elastomer composition described above, the extrusion coating melt temperature is greater than about 450° F. (232° C.), preferably greater than or equal to about 500° F. (about 260° C.), or is between about 450° (about 232° C.) and about 650° F. (about 343° C.), more preferably between about 475° (about 246° C.) and about 600° F. (about 316° C.), most preferably between about 500° and about 550° F. (about 260° and about 288° C.).

Auxiliary equipment such as a pre-heater can be used. In particular, a heater, such as a convection oven or infrared panels can be used to heat the back of the greige good before the adhesive backing material is extruded thereon. In doing so, it has been found that the encapsulation and penetration of the yarn bundles can be enhanced. Preferably, the pre-heater is an infrared unit set at between about 0 and about 100° C. and the greige good is exposed to this heating for between about 3 and about 30 seconds. Most preferably, the heater is set at about 50° C. and the greige good is exposed to this heating for about 5 to about 7 seconds (e.g., 6 seconds).

As another piece of auxiliary or optional equipment, a vacuum nip roll can be used to draw the adhesive backing material extrudate (i.e., semi-molten or molten polymer web) onto the greige good. In a properly configured extrusion coating operation, the pile face of the greige good is positioned towards the vacuum nip roll and the polymer web is draw down onto the back surface of the primary backing material of the greige good. Vacuum nip roll 24 (which is illustrated in FIG. 2 and is available from Black Clawson Corporation) is suitable for vacuum drawing the adhesive backing material web. Vacuum nip roll 24 can be adapted from a conventional nip roll wherein a portion of the hollow internal of the roll is partitioned, dedicated and coupled to an external vacuum pump 27 to provide a vacuum surface. The surface of the vacuum portion is perforated but machined flush and continuously with the remaining surface of the roll. Suitable vacuum nip rolls can have a complete 360 degree vacuum surface; however, a vacuum surface of from about 10 to about 180 degrees is preferred, most preferably about 60 degrees. To effectively draw the adhesive backing material web onto the greige good and maximize to the penetration of the yarn or fiber bundles, the vacuum is set to greater than 15 inches of H₂O (3.7 Pa), preferably greater than or equal to 25 inches of H₂O (6.1 Pa) and more preferably greater than or equal to 40 inches of H₂O (9.8 Pa), or from between about 15 and about 50 inches of H₂O (about 3.7 and about 12.3 Pa), preferably from between about 20 and about 45 (about 4.9 and about 11.1 Pa).

The length of time the greige good is actually subjected to the vacuum will primarily depend on the extrusion coating line speed and the extent of draw on the adhesive backing material web will largely depend on the level of vacuum and the porosity of the greige good. As such, higher vacuum levels will be required for higher extrusion coating line speeds and/or denser greige good to effectively the draw the adhesive backing material.

In addition to or as an alternative to a vacuum nip roll, a high pressure positive air device such as an air blade or knife can also be used to force the adhesive backing material web onto the back surface of the primary backing material. Preferably, the positive air pressure device is set to provide an air pressure greater than 20 psi (0.14 MPa), preferably greater than or equal to 40 psi (0.27 MPa), more preferably greater than or equal to 60 psi (0.41 MPa), or between about 20 and about 120 psi (about 0.14 and about 0.82 MPa), most preferably between about 30 and about 80 psi (about 0.20 and about 0.54 MPa) Preferably, the positive air pressure device is positioned at the extrusion coating nip, extends across the entire width of the polymer web and is positioned behind the polymer web towards the chill roll so to force the polymer web onto the greige good and press the polymer web into the yarn or fiber bundles.

The extruded polypropylene elastomer can either be used neat, or can have one or more additive included. A preferred additive is an inorganic filler, more preferably, an inorganic filler with a high heat content. Examples of such fillers include, but are not limited to, calcium carbonate, aluminum trihydrate, talc, barite. High heat content fillers are believed to be advantageous in the invention because such fillers allow the extrudate to remain at elevated temperatures longer with the beneficial result of providing enhanced encapsulation and penetration. That is, normally fillers are added to carpet backing materials to merely add bulk (i.e. as extenders) or to impart insulating and sound dampening characteristics. However, it is contemplated that inorganic mineral fillers that have high heat contents can improve yarn encapsulation and penetration which in turn improves the performance of the abrasion resistance and tuft bind strength of extrusion coated carpet samples.

Optionally, a high heat content filler is added at a level of between about 1 and about 75 weight percent of the total extrudate, more preferably between about 15 and about 60 weight percent and most preferably between about 20 weight percent and 50 weight percent. Such fillers will have a specific heat content of greater than or equal to 0.4 cal-cc/° C. (1.8 Joules-cc/° C.), preferably greater than or equal to 0.5 cal-cc/° C. (2 Joules-cm³/° C.), more preferably greater than or equal to 0.6 cal-cc/° C. (2.5 Joules-cm³/° C.), and most preferably greater than or equal to about 0.7 cal-cc/° C. (2.9 Joules-cm³/° C.). Representative examples of high heat content fillers for use in the present invention include, but are not limited to, limestone (primarily CaCO₃), marble, quartz, silica, and barite (primarily BaSO₄). The high heat content fillers should be ground or precipitated to a size that can be conveniently incorporated in an extrusion coating melt stream. Suitable particle sizes range from about 1 to about 50 microns.

If a foamed backing is desired on the carpet, a blowing agent can be added to the adhesive backing material. If used, the blowing agents are preferably conventional, heat activated blowing agents such as azodicarbonamide, toluene sulfonyl semicarbazide, and oxy bis(benzene sulfonyl) hydrazide. The amount of blowing agent added depends on the degree of foaming sought. A typical level of blowing agent is between about 0.1 and about 3.0 weight percent.

Optionally, implosion in the present invention can be accomplished by restricting expansion of the adhesive backing material in the direction opposite the primary backing material during activation of the implosion agent such that the molten polymer is forced into the interior and free space of the yarn or fiber bundles. An imploded adhesive backing material will have a collapsed, non-expanded matrix (relative to a foamed backing) and be of essentially the same thickness (measured from the plane of the back surface of the primary backing material) as would be the case without the use of the implosion agent. That is, the adhesive backing material layer would be characterized as not being expanded by the implosion agent.

The implosion agent can be selected and formulated into the adhesive backing material and extrusion conditions are set such that the activation of the implosion agent occurs at the instant of nip while the adhesive backing material is still semi-molten or molten. With improved yarn penetration accomplished with the use of an implosion agent, the carpet will exhibit comparatively improved abrasion resistance. Thus, the use of an implosion agent can allow the use of polymer compositions having lower molecular weights to provide improved extrusion coatability yet maintain higher abrasion resistance (i.e., comparable to adhesive backing materials based on higher molecular weight polymer compositions). An effective amount of implosion agent would be between about 0.1 and about 1.0 weight percent based on the weight of the adhesive backing material.

Conventional blowing agents or any material that ordinarily functions as a blowing agent can be used as an implosion agent in the present invention providing expansion of the adhesive backing material matrix is suitably restricted or confined when the material is activated such that molten polymer is forced into the interior and free space of the yarn or fiber bundles and there is no substantial expansion of the adhesive backing material as a result of having used the implosion agent. However, preferably, an imploded adhesive backing material will be characterized as having a closed cell structure that can be conveniently identified by photomicrographs at 50× magnification.

Other additives can also be included in the adhesive backing material, to the extent that they do not interfere with the enhanced properties discovered by Applicants. For example, antioxidants such as sterically hindered phenols, sterically hindered amines and phospites may be used. Suitable antioxidants include Irganox® 1010 from Ciba-Geigy which is a hindered phenol and Irgafos® 168 from Ciba-Geigy which is a phosphite. Other possible additives include antiblock additives, pigments and colorants, anti-static agents, antimicrobial agents (such as quaternary ammonium salts) and chill roll release additives (such as fatty acid amides).

The extrusion backed carpet or rug construction and the methods described herein are particularly suited for making carpet pieces and/or carpet rugs.

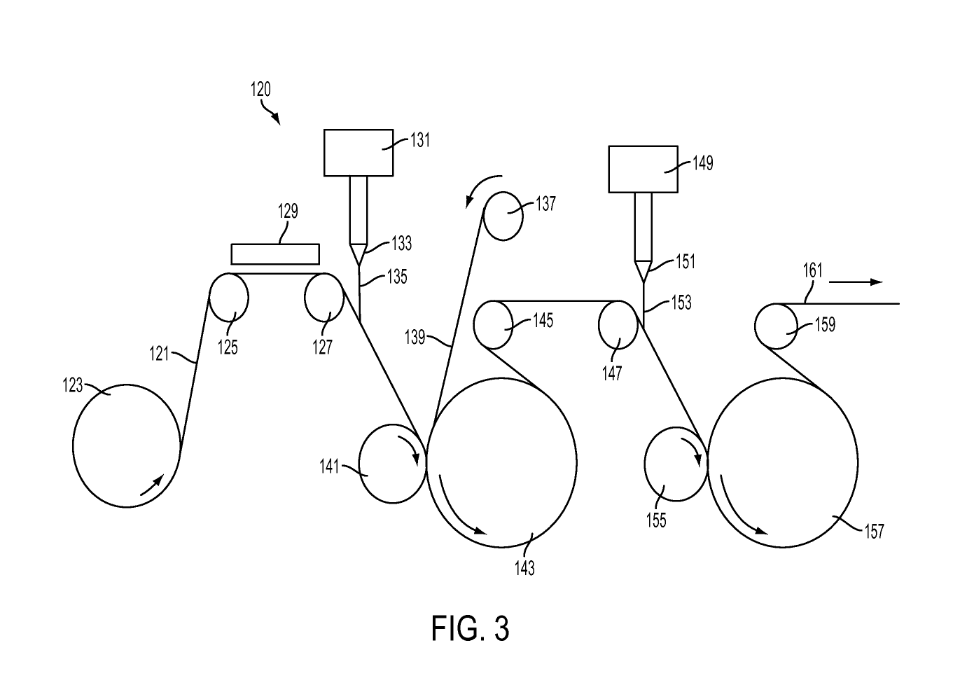

FIG. 3 schematically shows a preferred line 120 for making carpet pieces according to the present invention. A length of greige good 121, i.e. yarn tufted into a primary backing, is unrolled from the roll 123. The greige good 121 passes over the rollers 125 and 127 with the primary backing toward the roller 123. Between rollers 125 and 127 is a pre-heater 129 as described above.

An extruder 131 is mounted so as to extrude the adhesive backing composition comprising polypropylene elastomers through the die 133 onto the back of the greige good at a point between the roller 127 and the nip roll 141. The exact location at which the sheet 135 contacts the greige good can be varied depending on the line speed and the time desired for the molten polymer to rest on the greige good before passing between the nip roll 141 and the chill roll 143. At present it is preferred that the sheet 135 contact the greige good so as to lie on the greige good for between about 0.5 and about 2 seconds, most preferably about 1 second, before passing between the nip roll 141 and the chill roll 143.

The pressure between the nip roll 141 and the chill roll 143 can be varied depending on the force desired to push the extruded sheet. Most preferably, there is 60 psi (0.41 MPa) of air pressure pushing the rolls together. Also, as described in connection with FIG. 2, it may be desirable to include a vacuum slot in the nip roll. In addition, a jet of pressurized air may also be used to push the extruded sheet into the carpet backing.

The size of the chill roll 143 and the length of time the carpet rolls against it can be varied depending on the level of cooling desired in the process. Preferably the chill roll 143 is cooled by simply passing ambient water through it.

Carpet pieces or rugs are typically made by producing a length of backed carpet and then cutting the carpet into the appropriate desired sized carpet pieces. If desired the carpet pieces can be conventionally bound. In one aspect, the binding materials can be selected to match the chemical composition of the formed carpet piece so that if an optional dyeing process is used, the color penetration will be more adequately controlled.

In one aspect, it is contemplated that the greige good could be dyed or otherwise colorized prior to the application of the adhesive backing. Optionally, another preferred embodiment of the present invention, allows for the dyeing of the formed carpet pieces before or after being bound. It is contemplated that the carpet pieces can be placed in a conventional dye process and dyed by using suitable dye types and dye auxiliaries, which are dependent on fiber type and product requirements.

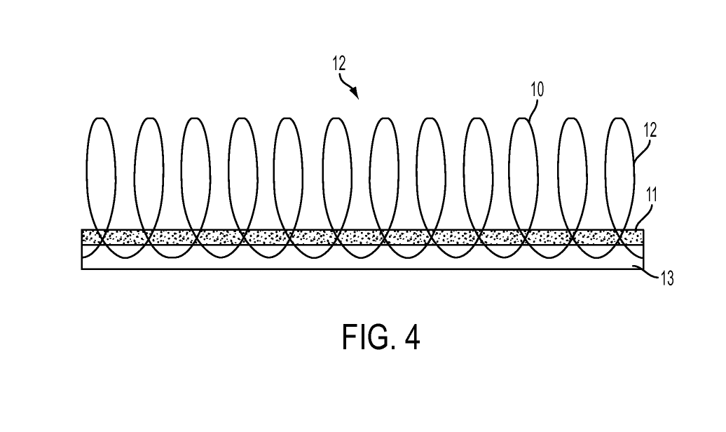

In still another aspect, the extrusion backed carpet construction and the methods described herein are particularly suited for making a carpet rug of the present invention. FIG. 4 shows an exemplary cross-section of a carpet rug 20 made according to the present invention. A face yarn is tufted into a primary backing so as to leave a carpet pile face on top of the primary backing and back stitches exposed below the primary backing. Applied to the back of the primary backing and in integration with at least a portion of the exposed back stitches is the adhesive backing layer. As one skilled in the art will appreciate, a further backing material can be adhered or otherwise attached to the bottom surface of the adhesive backing layer.

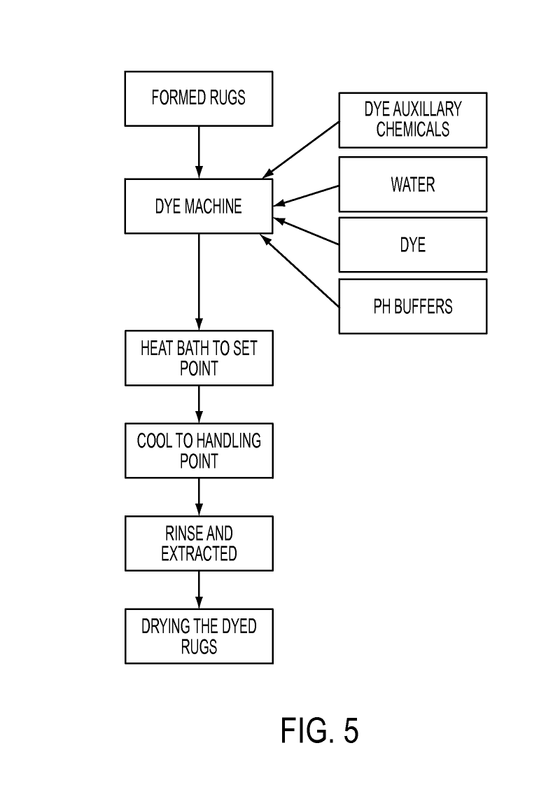

In one exemplary aspect, and referring to FIG. 5, the rugs to be dyed are added to a conventional dye machine and water is added to the machine to obtain a desired liquor ratio of 10:1. Subsequently, dye auxiliary chemicals can be added to the dye machine. In one aspect, for example and without limitation, these auxiliary chemicals can comprise water treatment materials, such as, for example and without limitation, anti-chlorine and sequestrants, defoamers and dyeing levelers. A dye is then added to obtain the required shade and PH buffers are added to obtain the required dyeing pH.

In operation, the bath is heated to a required set point and the temperature is held to provide adequate migration of the dyestuffs into the fiber of the carpet piece. Next, the bath is allowed to cool to a temperature that is suitable for handling of the dyed carpet pieces. In a further step, the dyed carpet pieces are rinsed and extracted and are subsequently directed to a drying process which is operated until the carpet pieces are dried. Finally, the rugs are allowed to cool to a safe handling temperature.

Washing is well known method used in rugs where the rug is placed into a typical household washing machine as is the type used to launder clothing. Repeated washing is a measure used to determine durability to washing. Washing is very important to the consumer to increase the useful life of any rug. A typical target is to achieve 3 washings with minimal change to the rug backing. It has been repeatedly demonstrated that the run of the present invention contains enhanced durability to washing, which allows for in excess of 10, 15 and/or 25 washings with minimal degradation of the rug backing and no loss of the plurality of fibers that are attached to the primary backing material. Thus, the rug of the present invention far exceeds the washability durability of existing conventional rugs.

While particular preferred and alternative embodiments have been described herein, it should be noted that various other embodiments and modifications can be made without departing from the scope of the inventions described herein. It is the appended claims which define the scope of the patent issuing from the present application

What is claimed is:

1. A rug comprising:
a primary backing material having a face and a back side, a plurality of fibers attached to the primary backing material and extending from the face of the primary backing material and exposed at the back side of the primary backing material, and
an adhesive backing material adjacent to the back side of the primary backing material, wherein the adhesive backing material comprises a thermoplastic elastomer that is in intimate contact with the back surface of the primary backing material and has substantially penetrated and consolidated the fibers to form a monolithic structure in which the consolidated fibers have high tuft bind strength.

2. The rug of claim 1, wherein the thermoplastic elastomer comprises a polyolefin elastomer.

3. The rug of claim 1, wherein the thermoplastic elastomer comprises a polypropylene elastomer.

4. The rug of claim 1, wherein the adhesive backing material is comprised of an effective amount of at least one additive selected from the group consisting of: a blowing agent and high heat content filler with the proviso that where the blowing agent is selected, the adhesive backing material is further characterized as having a substantially foamed, frothed or expanded non-collapsed matrix.

5. The rug of claim 1, wherein the primary backing material and the plurality of fibers are dyed prior to the application of the adhesive layer.

6. The rug of claim 1, wherein the primary backing material and the plurality of fibers are dyed after the application of the adhesive layer.

7. A rug, comprising:
a rug construct comprising:
a primary backing with a face side and a back side;
yarn tufted into the primary backing so as to produce a carpet pile on the face side of the primary backing and loops of yarn on the back side of the primary backing; and
a first polymeric adhesive layer of a thermoplastic elastomer extruded onto the back side of the primary backing and the loops of yarn on the back side of the primary backing, wherein the thermoplastic elastomer is in intimate contact with the back surface of the primary backing and has substantially penetrated and consolidated to a portion of the yarn to form a monolithic structure in which the consolidated yarn has a tuft bind strength.

8. The rug of claim 7, further comprising a means for cutting the rug construct into at least one rug of a desired dimension.

9. The rug of claim 8, further comprising a means for dyeing at least one rug.

10. The rug of claim 9, wherein the primary backing material and the yarn are dyed prior to the application of the adhesive layer.

11. The rug of claim 9, wherein the primary backing material and the yarn are dyed after the application of the adhesive layer.

12. The rug of claim 7, wherein the thermoplastic elastomer comprises a polyolefin elastomer.

13. The rug of claim 7, wherein the thermoplastic elastomer comprises a polypropylene elastomer.

14. The rug of claim 7, wherein the primary backing and the yarn are all made from a polypropylene.

15. The rug of claim 7, wherein the primary backing and the yarn are all made from a nylon.

16. The rug of claim 7, wherein the primary backing and the yarn are all made from a polyester.

17. The rug of claim 7, wherein the primary backing and the yarn are all made from a polyethylene.

18. The rug of claim 7, wherein the primary backing is formed from a material selected from the group consisting of: nylon, polyester, wool, cotton, polytrimethylene terephthalate, Polylactic acid, polypropylene; and polyethylene or a combination of those materials, and wherein the yarn is formed from a material selected from the group consisting of: nylon, polyester, wool, cotton, polytrimethylene terephthalate, Polylactic acid, polypropylene, and polyethylene or a combination of those materials.

19. The rug of claim 7 wherein the rug contains enhanced durability to washing that exceeds 25 washings as performed with a conventional washing machine.

20. A method of making a rug, comprising the steps:
providing a primary backing with a face side and a back side, wherein the primary backing has a determined production size;
tufting a yarn into the primary backing so as to produce a carpet pile on the face side of the primary backing and loops of yarn on the back side of the primary backing;
extruding an adhesive layer of a thermoplastic elastomer onto the back side of the primary backing so as to at least partially penetrate the primary backing, the loops of yarn on the back side of the primary backing or both to make a rug of the determined production size and to form a monolithic structure in which the consolidated yarn has a high tuft bind strength.

21. The method of claim 20, further comprising cutting at least one rug of a desired size and shape from the rug of the determined production size.

22. The method of claim 20, further comprising the step of dyeing of at least one rug.

23. The method of claim 20, further comprising the step of dyeing the primary backing and yarn prior to the step of extruding the adhesive layer onto the back side of the primary backing.

24. The method of claim 20, further comprising the step of dyeing the primary backing and yarn after the step of extruding the adhesive layer onto the back side of the primary backing.

25. The method of claim 20, wherein the thermoplastic elastomer comprises a polyolefin elastomer.

26. The method of claim 20, wherein the thermoplastic elastomer comprises a polypropylene elastomer.

27. The method of claim 20, wherein the primary backing is formed from a material selected from the group consisting of: nylon, polyester, wool, cotton, polytrimethylene terephthalate, Polylactic acid, polypropylene; and polyethylene or a combination of those materials, and wherein the yarn is formed from a material selected from the group consisting of: nylon, polyester, wool, cotton, polytrimethylene terephthalate, Polylactic acid, polypropylene, and polyethylene or a combination of those material.

28. The method of claim 20, wherein the primary backing, the yarn, and the polymeric adhesive layer are all made from a polypropylene.

29. The method of claim 20, wherein the polymeric adhesive layer contains an inorganic filler.

30. The method of claim 20, wherein the polymeric adhesive layer comprises an additive to increase the adhesiveness of the layer.

31. The method of claim 20, further comprising cutting at least one rug of a desired size and shape from the rug of the determined production size.
